(19) United States
(12) Patent Application Publication
(10) Pub. No.: US 2019/0146317 A1
(43) Pub. Date: May 16, 2019

(54) WAVELENGTH CONVERSION DEVICE, LIGHT SOURCE DEVICE, LIGHTING APPARATUS, AND PROJECTION IMAGE DISPLAY APPARATUS

(71) Applicant: PANASONIC INTELLECTUAL PROPERTY MANAGEMENT CO., LTD., Osaka (JP)

(72) Inventors: Kenta WATANABE, Osaka (JP); Toshio MORI, Kyoto (JP); Hiroshi ASANO, Osaka (JP); Yosuke HONDA, Nara (JP); Ran ZHENG, Osaka (JP); Sachiko AZUMA, Osaka (JP)

(73) Assignee: PANASONIC INTELLECTUAL PROPERTY MANAGEMENT CO., LTD., Osaka (JP)

(21) Appl. No.: 16/183,430

(22) Filed: Nov. 7, 2018

(30) Foreign Application Priority Data
Nov. 10, 2017 (JP) 2017-217634

(51) Int. Cl. G03B 21/20; G03B 21/00

(52) U.S. Cl. CPC G03B 21/204; G03B 21/2093; G03B 21/006

(57) ABSTRACT

A wavelength conversion device is provided that includes: light-transmissive substrate that includes an incidence surface and an emission surface opposite the incidence surface, and emits, from the emission surface, laser light that enters the incidence surface; a phosphor layer that emits fluorescent light when excited by the laser light emitted from the emission surface; and a light diffuser layer between the emission surface and the phosphor layer. The light diffuser layer is, when viewed in a direction perpendicular to the emission surface, disposed only in a portion of a region in which the phosphor layer is disposed.

### CROSS REFERENCE TO RELATED APPLICATION

This application claims the benefit of priority of Japanese Patent Application Number 2017-217634 filed on Nov. 10, 2017, the entire content of which is hereby incorporated by reference.

### BACKGROUND

### 1. Technical Field

The present disclosure relates to a wavelength conversion device which emits light upon receiving laser light. In addition, the present disclosure relates to a light source device, a lighting apparatus, and a projection image display apparatus, which include the above-described wavelength conversion device.

### 2. Description of the Related Art

In recent years, a light source device in which a solid-state light-emitting element which emits laser light and a wavelength conversion device including phosphor particles are combined has been proposed. Japanese Unexamined Patent Application Publication No. 2012-68647 discloses a light source device for a projector which includes a light-emitting wheel as the above-described wavelength conversion device.

### SUMMARY

In a wavelength conversion device, a temperature rises prominently in a region irradiated with laser light that is relatively high in intensity, leading to a decrease in emission efficiency of phosphor particles. In addition, emission efficiency of the phosphor particles decreases due to luminance saturation of the phosphor particles as well. Such local temperature rise causes damage to the wavelength conversion device due to thermal expansion.

The present disclosure provides a wavelength conversion device capable of inhibiting local temperature rise in a phosphor layer and a decrease in emission efficiency of phosphor particles. In addition, the present disclosure provides a light source device, a lighting apparatus, and a projection image display apparatus which include the above-described wavelength conversion device.

A wavelength conversion device according to an aspect of the present disclosure includes: a light-transmissive substrate that includes an incidence surface and an emission surface opposite the incidence surface, and emits, from the emission surface, laser light that enters the incidence surface; a phosphor layer that emits fluorescent light when excited by the laser light emitted from the emission surface; and e light diffuser layer between the emission surface and the phosphor layer. In the wavelength conversion device, when viewed in a direction perpendicular to the emission surface, the light diffuser layer is disposed only in a portion of a region in which the phosphor layer is disposed.

A light source device according to an aspect of the present disclosure includes the wavelength conversion device, and a laser light source that emits the laser light that enters the incidence surface.

A lighting apparatus according to an aspect of the present disclosure includes the light source device, and an optical component that condenses or diffuses light emitted by the light source device.

A projection image display apparatus according to an aspect of the present disclosure includes: the light source device; an imaging element that modulates light emitted by the light source device, and outputs, as an image, modulated light; and a projection lens that projects the image output by the imaging element.

A wavelength conversion device according to an aspect of the present disclosure includes: a light-transmissive substrate that includes an incidence surface and an emission surface opposite the incidence surface, and emits, from the emission surface, laser light that enters the incidence surface; and a phosphor layer that emits fluorescent light when excited by the laser light emitted from the emission surface. In the wavelength conversion device, the light-transmissive substrate includes a light diffuser which diffuses the laser light that enters the incidence surface, and when viewed in a direction perpendicular to the emission surface, the light diffuser is disposed only in a portion of a region in which the phosphor layer is disposed.

With the wavelength conversion device, the light source device, the lighting apparatus, and the projection image display apparatus according to the present disclosure, local temperature rise in a phosphor layer and a decrease in emission efficiency of phosphor particles are inhibited.

### BRIEF DESCRIPTION OF DRAWINGS

The figures depict one or more implementations in accordance with the present teaching, by way of examples only, not by way of limitations. In the figures, like reference numerals refer to the same or similar elements.

FIG. 1 illustrates an external perspective view of a wavelength conversion device according to Embodiment 1;

FIG. 2 illustrates a plan view of the wavelength conversion device according to Embodiment 1;

FIG. 3 illustrates a schematic cross-sectional view taken along the line III-III of FIG. 2;

FIG. 4 is a diagram which illustrates a first example of placement of a light diffuser layer;

FIG. 5 is a diagram which illustrates a second example of placement of the light diffuser layer;

FIG. 6 is a diagram which illustrates a third example of placement of the light diffuser layer;

FIG. 7 is a diagram which illustrates a fourth example of placement of the light diffuser layer;

FIG. 8 illustrates a schematic cross-sectional view of a wavelength conversion device according to a variation example;

FIG. 9 illustrates an external perspective view of a lighting apparatus according to Embodiment 2;

FIG. 10 is a schematic cross-sectional view which illustrates a use mode of the lighting apparatus according to Embodiment 2;

FIG. 11 illustrates an external perspective view of a projection image display apparatus according to Embodiment 3; and

FIG. 12 is a diagram which illustrates an optical system included in the projection image display apparatus according to Embodiment 3.

### DETAILED DESCRIPTION OF THE EMBODIMENTS

Hereinafter, embodiments of the present disclosure will be described with reference to the drawings. It should be noted that the embodiments described below each show a general or specific example. Thus, the numerical values, shapes, materials, structural components, the disposition and connection of the structural components, and others described in the following embodiments are mere examples, and do not intend to limit the present disclosure. Furthermore, among the structural components in the following embodiments, structural components not recited in any one of the independent claims which indicate the broadest concepts of the present disclosure are described as arbitrary structural components.

In addition, each diagram is a schematic diagram and not necessarily strictly illustrated. In each of the diagrams, substantially the same structural components are assigned with the same reference signs, and redundant descriptions will be omitted or simplified.

In addition, there are instances where coordinate axes are illustrated in the diagrams used to describe the following embodiments. The Z-axis direction in the coordinate axes is, for example, the vertical direction, the Z-axis positive side is referred to as the top side (upward), and the Z-axis negative side is referred to as the bottom side (downward). Stated differently, the Z-axis direction is a direction perpendicular to an incidence surface or an emission surface of a substrate included in a wavelength conversion device. Furthermore, the X-axis direction and the Y-axis direction are mutually orthogonal directions in a plane (horizontal plane) perpendicular to the Z axis direction. The X-Y plane is a plane parallel to the incidence surface or the emission surface of the substrate included in the wavelength conversion device. For example, in the following embodiments, the expression “in a plan view” means a view in the Z-axis direction.

### Embodiment 1

### Configuration of Wavelength Conversion Device

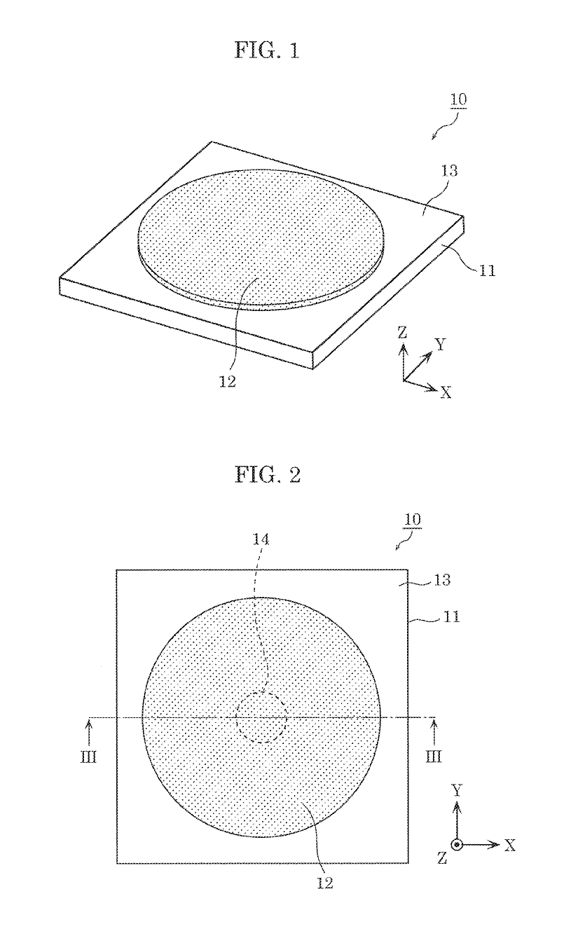

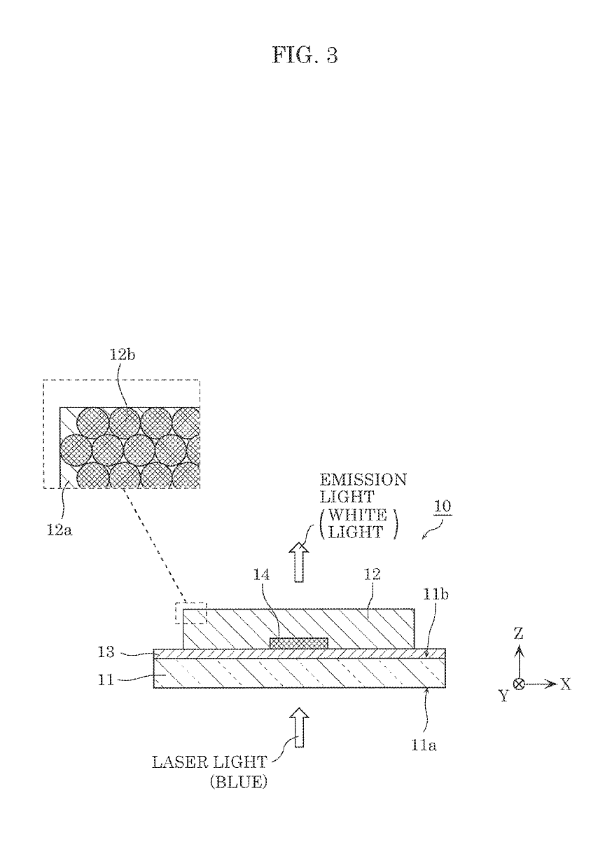

First, a configuration of a wavelength conversion device according to Embodiment 1 will be described with reference to the drawings. FIG. 1 is an external perspective view of the wavelength conversion device according to Embodiment 1. FIG. 2 is a plan view of the wavelength conversion device according to Embodiment 1. FIG. 3 is a schematic cross-sectional view of the wavelength conversion device, taken along the line III-III of FIG. 2. It should be noted that, in FIG. 3, there are instances where a magnitude correlation between the thicknesses of the structural components, for example, is not accurately described.

Wavelength conversion device 10 according to Embodiment 1 illustrated in FIG. 1 to FIG. 3 is a device that emits fluorescent light when excited by excitation light. Specifically, wavelength conversion device 10 includes light-transmissive substrate 11, phosphor layer 12, optical thin film 13, and light diffuser layer 14. Phosphor layer 12 contains phosphor particles 12b which are excited by excitation light to emit fluorescent light. In other words, wavelength conversion device 10 is a light-transmissive phosphor plate, converts a wavelength of a portion of blue laser light (excitation light) emitted by a laser light source into a wavelength of yellow fluorescent light, and emits the yellow fluorescent light. Wavelength conversion device 10 emits white light including blue laser light which passes through phosphor layer 12 and the yellow fluorescent light emitted by phosphor particles 12b. It should be noted that wavelength conversion device 10 may be a phosphor wheel used in a projection image display apparatus.

Light-transmissive substrate 11 is a substrate formed using a light-transmissive material. Light-transmissive substrate 11 includes incidence surface 11a and emission surface 11b opposite incidence surface 11a, and emits, from emission surface 11b, laser light which enters light-transmissive substrate 11 through incidence surface 11a. Incidence surface 11a is, stated differently, a first main surface on the Z-axis negative side, and emission surface 11b is, stated differently, a second main surface on the Z-axis positive side. Incidence surface 11a and emission surface 11b face the opposite directions. Optical thin film 13 is disposed on emission surface 11b.

Light-transmissive substrate 11 is a sapphire substrate, specifically. Light-transmissive substrate 11 may be any other light-transmissive substrate, such as a light transmissive ceramic substrate formed using polycrystal alumina or aluminum nitride, a transparent glass substrate, a quartz substrate, or a transparent resin substrate. In addition, light-transmissive substrate 11 may have another shape in a plan view, such as a circular shape.

Optical thin film 13 is a thin film having a property which transmits light of a blue wavelength region, and reflects light of a yellow wavelength region. More specifically, optical thin film 13 has a property that transmits laser light emitted by the laser light source, and reflects fluorescent light emitted by phosphor layer 12. With optical thin film 13, it is possible to increase emission efficiency of wavelength conversion device 10. Optical thin film 13 is, stated differently, a dichroic mirror layer.

Optical thin film 13 is located between emission surface 11b and phosphor layer 12. More specifically, optical thin film 13 is disposed on emission surface 11b, and covers the entirety of emission surface 11b. It should be noted that it is sufficient that optical thin film 13 covers at least portion of emission surface 11b.

Phosphor layer 12 emits fluorescent light when excited by laser light which is emitted from emission surface 11b and passes through optical thin film 13. Phosphor layer 12 is formed on a portion of optical thin film 13. Although phosphor layer 12 has a circular shape in a plan view, phosphor layer 12 may have another shape such as a rectangular shape or an annular shape.

Phosphor layer 12 includes base material 12a and phosphor particles 12b. Phosphor layer 12 is formed by printing, on light-transmissive substrate 11, a paste formed using base material 12a including phosphor particles 12b, for example.

Base material 12a is formed using an inorganic material such as glass, or using an organic-inorganic hybrid material. As described above, since base material 12a includes an inorganic material, it is possible to increase a heat dissipation performance of wavelength conversion device 10.

Phosphor particles 12b are dispersedly disposed in phosphor layer 12 (base material 12a), and emits light when excited by blue laser light emitted by the laser light source. In other words, phosphor particles 12b emit fluorescent light when excited by excitation light. Phosphor particles 12b are, specifically, yttrium-aluminum-garnet (YAG) yellow phosphors such as Y₃(Al, Ga)₅O₁₂:Ce phosphors, and emit yellow fluorescent light. It should be noted that phosphor particles 12b may be lutetium-aluminum-garnet (LuAG) yellow phosphors such as Lu₃Al₅O₁₂:Ce phosphors. The yellow phosphor particles are, for example, phosphor particles having a fluorescent light peak wavelength of at least 540 nm and at most 600 nm. Phosphor particles 12b may be LuAG green phosphors or YAG green phosphors.

Most of phosphor particles 12b included in phosphor layer 12 are directly in contact with other phosphor particles 12b. As described above, since such a densely-arranged state of phosphor particles 12b is held in wavelength conversion device 10, heat generated in one of phosphor particles 12b is easily conducted to the other phosphor particles 12b. Accordingly, the heat dissipation property is improved.

Light diffuser layer 14 diffuses laser light which is emitted from emission surface 11b and passes through optical thin film 13. Light diffuser layer 14 is located between emission surface 11b and phosphor layer 12, and faces only a portion of a surface of phosphor layer 12 adjacent to light-transmissive substrate 11. More specifically, phosphor layer 14 is formed partially on optical thin film 13. In other words, light diffuser layer 14 is disposed only in a portion of the region in which phosphor layer 12 is disposed, when viewed in a direction perpendicular to emission surface 11b. Light diffuser layer 14 has a circular shape when viewed in the direction perpendicular to emission surface 11b. However, light diffuser layer 14 may have another multiangular shape such as a rectangular shape when viewed in the direction perpendicular to emission surface 11b. It should be noted that, in the following embodiments, the phrase “when viewed in a direction perpendicular to emission surface 11b” is also stated as “in a plan view”.

Light diffuser layer 14 partially diffuses laser light travelling to phosphor layer 12. Accordingly, when a position at which laser light has a highest intensity in an emission range of the laser light overlaps light diffuser layer 14 in a plan view, laser light having a high intensity is diffused before the laser light enters phosphor layer 12. As a result, it is possible to inhibit laser light having a high intensity from directly entering phosphor layer 12, and local temperature rise in phosphor layer 12 can be inhibited.

Light diffusing layer 14 is formed by, for example, dispersing light diffuser particles such as alumina or silica into a base material that is the same material as base material 12a of phosphor layer 12. With this, it is possible to inhibit an interface from being formed between phosphor layer 12 and light diffuser layer 14, and thus utilization efficiency of light can be increased.

In addition, light diffuser layer 14 may include a base material that is a material different from base material 12a of phosphor layer 12. For example, light diffusing layer 14 may include zinc oxide that is high in refractive index, as a base material. In this case, laser light is diffused by bubbles included in zinc oxide, for example.

It should be noted that laser light diffused by light diffuser layer 14 partially travels back to an incidence-surface side, and cannot be extracted from an emission-surface side. Accordingly, when light diffuser layer 14 has an excessively large area in a plan view, the light extraction efficiency of wavelength conversion device 10 decreases. Thus, an optimum area of light diffuser layer 14 in a plan view may be arbitrarily determined based on various factors such as a temperature of an environment in which wavelength conversion device 10 is used, luminance saturation of the phosphor particles, temperature quenching, etc.

### First Example of Placement of Light Diffuser Layer

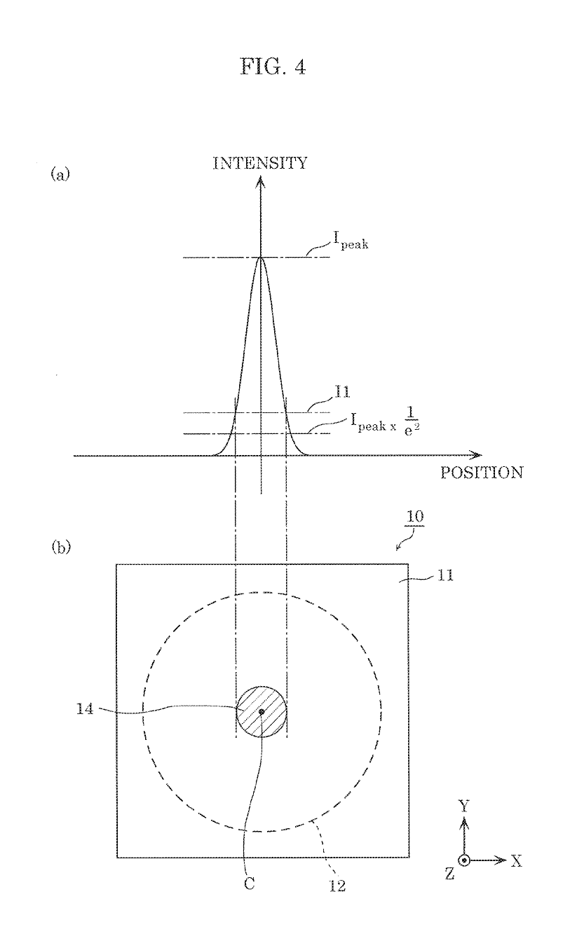

The following describes placement of light diffuser layer 14. FIG. 4 is a diagram which illustrates a first example of placement of light diffuser layer 14. In FIG. 4, (a) illustrates an intensity distribution of laser light emitted to wavelength conversion device 10, and (b) illustrates placement of light diffuser layer 14 in a plan view. It should be noted that phosphor layer 12 is illustrated by a dashed line in (b) in FIG. 4. The dashed line indicates a region in which phosphor layer 12 is disposed.

In the example illustrated in FIG. 4, the intensity distribution ((a) in FIG. 4) of laser light emitted to wavelength conversion device 10 is Gaussian distribution, and the laser light has peak intensity Iₚₑₐₖ at center position C in phosphor layer 12 in a plan view. It should be noted that the intensity distribution in this case is, for example, an intensity distribution at a position of laser light immediately before the laser light enters phosphor layer 12, and when light diffuser layer 14 is not included in wavelength conversion device 10. The intensity distribution may be an intensity distribution at other positions such as a position of incidence surface 11a or emission surface 11b of light-transmissive substrate 11, etc.

In this case, it is sufficient that light diffuser layer 14 is disposed at least at a position at which the intensity of laser light is maximum; that is, center position C. Accordingly, it is possible to inhibit laser light having a high intensity from directly entering phosphor layer 12, and local temperature rise in phosphor layer 12 can be inhibited.

In the example illustrated in FIG. 4, light diffuser layer 14 is disposed only in a region in which the intensity of laser light is greater than or equal to predetermined intensity I1 that is greater than 1e/² times peak intensity Iₚₑₐₖ. In the example illustrated in FIG. 4, such a region has, for example, a circular shape around center position C, and light diffuser layer 14 also has a circular shape.

With the placement of light diffuser layer 14 illustrated in FIG. 4, laser light having an intensity greater than or equal to predetermined intensity I1 is diffused by light diffuser layer 14 before the laser light enters phosphor layer 12. Accordingly, it is possible to inhibit laser light having an intensity greater than or equal to predetermined intensity I1 from directly entering phosphor layer 12, and local temperature rise in phosphor layer 12 can be inhibited. Since the local temperature rise in phosphor layer 12 is inhibited, a decrease in emission efficiency of phosphor particles 12b and damage of wavelength conversion device 10 due to thermally expand are inhibited.

### Second Example of Placement of Light Diffuser Layer

FIG. 5 is a diagram which illustrates a second example of placement of the light diffuser layer. In FIG. 5, (a) illustrates an intensity distribution of laser light emitted to wavelength conversion device 10a, and (b) illustrates placement of light diffuser layer 14a in a plan view. It should be noted that phosphor layer 12 is illustrated by a dashed line in (b) in FIG. 5.

In the example illustrated in FIG. 5, the intensity distribution of laser light emitted to wavelength conversion device 10a is Gaussian distribution, and the laser light has peak intensity Iₚₑₐₖ at center position C in phosphor layer 12 in a plan view. In the example illustrated in FIG. 5, light diffuser layer 14a is disposed only in a region in which the intensity of laser light is greater than or equal to predetermined intensity I2 that is greater than 1/e times peak. intensity Iₚₑₐₖ. Predetermined intensity I2 is greater than predetermined intensity I1. Such a region has, for example, a circular shape around center position C, and light diffuser layer 14a also has a circular shape.

With the placement of light diffuser layer 14a as illustrated in FIG. 5, laser light having an intensity greater than or equal to predetermined intensity I2 is diffused by light diffuser layer 14 before the laser light enters phosphor layer 12. Accordingly, it is possible to inhibit laser light having an intensity greater than or equal to predetermined intensity I2 from directly entering phosphor layer 12, and local temperature rise in phosphor layer 12 can be inhibited.

When predetermined intensity I2 is greater than predetermined intensity I1, an area of light diffuser layer 14a in a plan view is smaller than an area of light diffuser layer 14. As a result, with light diffuser layer 14a, laser light is less likely to travel back to the incidence-surface side, compared to the case where light diffuser layer 14 is used. In other words, with light diffuser layer 14a, it is possible to implement wavelength conversion device 10a which excels in light extraction efficiency.

### Third Example of Placement of Light Diffuser Layer

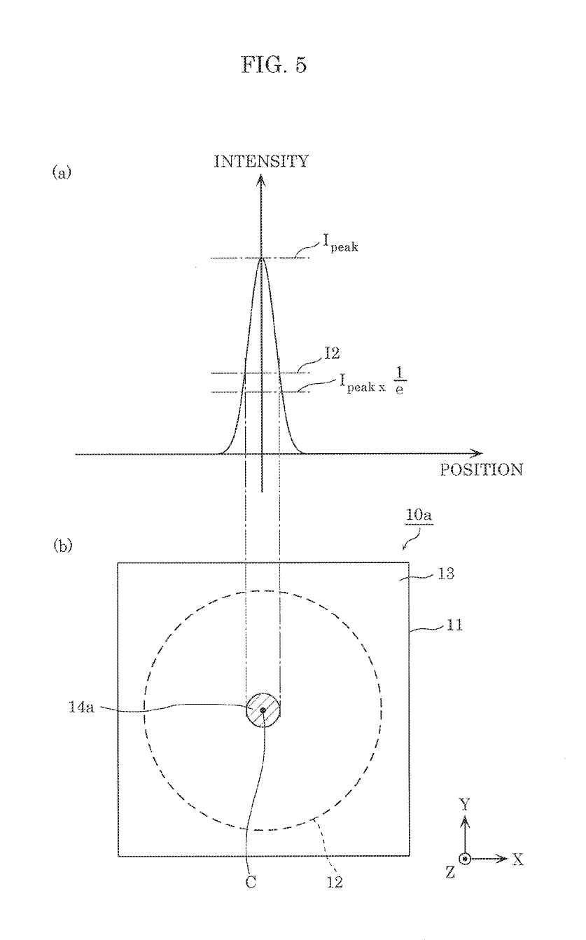

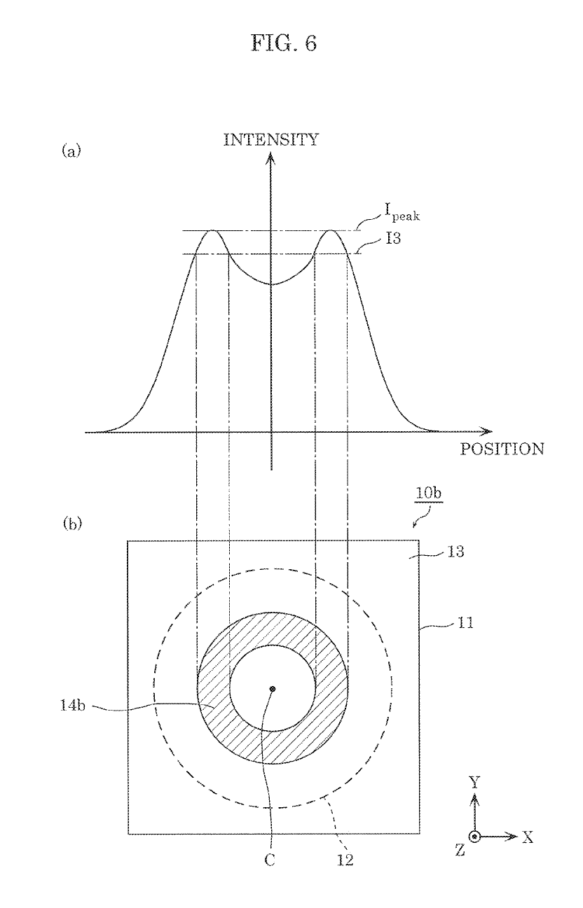

There are also instances where the intensity distribution of laser light emitted to wavelength conversion device 10 is not Gaussian distribution. For example, when a laser light source includes a plurality of semiconductor laser chips which are combined, there are instances where the intensity distribution of laser light emitted to wavelength conversion device 10 is not Gaussian distribution. FIG. 6 is a diagram which illustrates a third example of placement of the light diffuser layer, corresponding to an intensity distribution other than Gaussian distribution. In FIG. 6, (a) illustrates an intensity distribution of laser light emitted to wavelength conversion device 10b, and (b) illustrates placement of light diffuser layer 14b in a plan view. It should be noted that phosphor layer 12 is illustrated by a dashed line in (b) in FIG. 6.

The example illustrated in FIG. 6 shows that, in the intensity distribution of laser light emitted to wavelength conversion device 10b, the trajectory of the position of peak intensity Iₚₑₐₖ has an annular shape. The laser light emitted to wavelength conversion device 10b does not have peak intensity Iₚₑₐₖ at center position C of phosphor layer 12. In such a case, the region in which the intensity of laser light is greater than or equal to predetermined intensity I3 has an annular shape. Accordingly, light diffuser layer 14b which is disposed only in a region in which the intensity of laser light is greater than or equal to predetermined intensity I3 also has an annular shape.

As described above, light diffuser layer 14b may have an annular shape in a plan view. Alternatively, light diffuser layer 14b may have a multiangular shape, an annular rectangular shape, a racetrack shape, etc.

### Fourth Example of Placement of Light Diffuser Layer

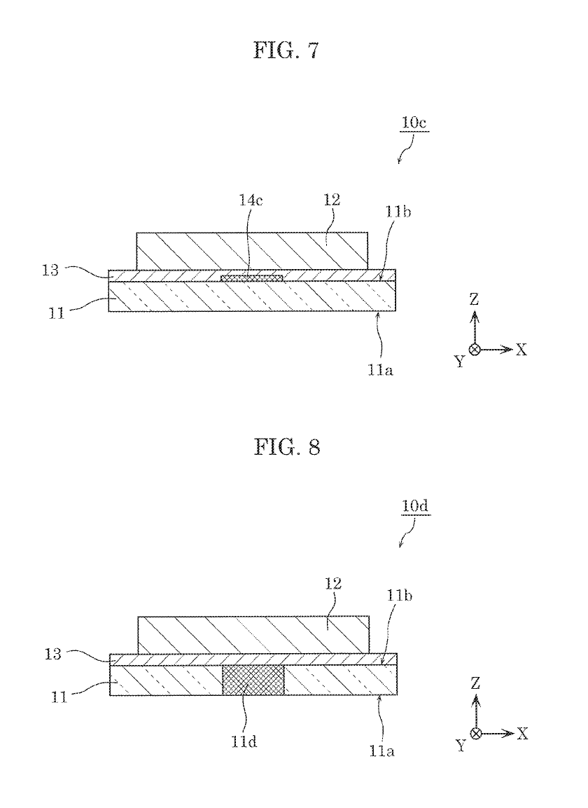

In the above-described embodiment, light diffuser layer 14 is located between optical thin film 13 and phosphor layer 12. However, the position of light diffuser layer 14 in a lamination direction is not limited to the position described above. FIG. 7 is a diagram which illustrates a fourth example of placement of the light diffuser layer. FIG. 7 is a schematic cross-sectional view.

Wavelength conversion device 10c illustrated in FIG. 7 includes light diffuser layer 14c located between optical thin film 13 and light-transmissive substrate 11. In a plan view, light diffuser layer 14c is disposed only in a portion of the region in which phosphor layer 12 is disposed. Light diffuser layer 14c has, for example, a circular shape in a plan view. However, light diffuser layer 14c may have another shape in a plan view, such as an annular shape. In addition, the specific configuration of light diffuser layer 14c is same as or similar to the specific configuration of light diffuser layer 14, etc.

### Variation

According to the foregoing embodiment, light diffuser layer 14 is provided separately from light-transmissive substrate 11. However, a portion of light-transmissive substrate 11 may serves as light diffuser layer 14. FIG. 8 is a schematic cross-sectional view of the wavelength conversion device according to such a variation example.

Light-transmissive substrate 11 included in wavelength conversion device 10d illustrated in FIG. 8 includes light diffuser 11d which diffuses laser light incident on incidence surface 11a. Light diffuser 11d is, for example, a region which is included in light-transmissive substrate 11, and has a light diffusion structure such as an uneven structure on a surface (incidence surface 11a or emission surface 11b). Light diffuser 11d may be a region which is included in light-transmissive substrate 11, and in which a light diffusion material such as alumina or silica is filled.

As with light diffuser layer N, etc. according to the above-described embodiment, light diffuser 11d is, in a plan view, disposed only in a portion of the region in which phosphor layer 12 is disposed. Light diffuser 11d partially diffuses laser light travelling to phosphor layer 12. Accordingly, when a position at which laser light has a highest intensity in an emission range of the laser light overlaps light diffuser lid in a plan view, laser light having a high intensity is diffused before the laser light enters phosphor layer 12. As a result, it is possible to inhibit laser light having a high intensity from directly entering phosphor layer 12, and local temperature rise in phosphor layer 12 can be inhibited.

In addition, the configuration in which a portion of light-transmissive substrate 11 serves as light diffuser 11d yields an advantages effect that it is not necessary to separately include light diffuser layer 14, etc.

It should be noted that the above-described placement examples (stated differently, exemplary shapes) illustrated in FIG. 4 to FIG. 6, etc. may be applied to light diffuser 11d. In other words, when viewed in a direction perpendicular to emission surface 11b, light diffuser 11d may be located at a position at which laser light has the highest intensity. When viewed in the direction perpendicular to emission surface 11b, light diffuser 11d may be disposed only in a region in which the intensity of laser light is greater than or equal to predetermined intensity I1. When viewed in the direction perpendicular to emission surface 11b, light diffuser 11d may be disposed only in a region in which the intensity of laser light is greater than or equal to predetermined intensity I2.

### Advantageous Effects, etc.

As described above, wavelength conversion device 10 includes: light-transmissive substrate 11 that includes incidence surface 11a and emission surface 11b opposite incidence surface 11a, and emits, from emission surface 11b, laser light that enters incidence surface 11a, phosphor layer 12 that emits fluorescent light when excited by the laser light emitted from emission surface 11b; and light diffuser layer 14 between emission surface 11b and phosphor layer 12. In wavelength conversion device 10, when viewed in a direction perpendicular to emission surface 11b, light diffuser layer 14 is disposed only in a portion of a region in which phosphor layer 12 is disposed.

With wavelength conversion device 10, when a position at which laser light has a highest intensity in an emission range of the laser light overlaps light diffuser layer 14 in a plan view, laser light having a high intensity is diffused before the laser light enters phosphor layer 12. As a result, it is possible to inhibit laser light having a high intensity from directly entering phosphor layer 12, and local temperature rise in phosphor layer 12 and a decrease in emission efficiency of phosphor particles can be inhibited.

In addition, for example, light diffuser layer 14 has a circular shape when viewed in the direction perpendicular to emission surface 11b.

Light diffuser layer 14 which has a circular shape as described above is capable of selectively diffusing a portion of laser light which has a high intensity, when the intensity distribution of the laser light is Gaussian distribution.

In addition, for example, light diffuser layer 14b has an annular shape when viewed in the direction perpendicular to emission surface 11b.

Light diffuser layer 14 which has an annular shape as described above is capable of selectively diffusing a portion of laser light which has a high intensity, when the intensity distribution of the laser light is the distribution as illustrated in FIG. 6.

In addition, for example, wavelength conversion device 10 further includes optical thin film 13 between emission surface 11b and phosphor layer 12. Optical thin film 13 has a property of transmitting the laser light and reflects the fluorescent light.

With optical thin film 13 as described above, it is possible to increase emission efficiency of wavelength conversion device 10.

In addition, in wavelength conversion device 10, light diffuser layer 14 is between optical thin film 13 and phosphor layer 12.

With this configuration, light diffuser layer 14c is capable of diffusing laser light emitted from optical thin film 13, before the laser light enters phosphor layer 12.

In addition, in wavelength conversion device 10, for example, light diffuser layer 14c is between optical thin film 13 and emission surface 11b.

With this configuration, light diffuser layer 14c is capable of diffusing laser light before the laser light enters optical thin film 13.

In addition, wavelength conversion device 10d includes: light-transmissive substrate 11 that includes incidence surface 11a and emission surface 11b opposite incidence surface 11a, and emits, from emission surface 11b, laser light that enters incidence surface 11a; and phosphor layer 12 that emits fluorescent light when excited by the laser light emitted from emission surface 11b. In wavelength conversion device 10d, light-transmissive substrate 11 includes light diffuser 11d which diffuses the laser light that enters incidence surface 11a, and when viewed in a direction perpendicular to emission surface 11b, light diffuser 11d is disposed only in a portion of a region in which phosphor layer 12 is disposed.

With wavelength conversion device 10d, when a position at which laser light has highest intensity in an emission range of the laser light overlaps light diffuser 11d in a plan view, laser light having a high intensity is diffused before the laser light enters phosphor layer 12. As a result, it is possible to inhibit laser light having a high intensity from directly entering phosphor layer 12, and local temperature rise in phosphor layer 12 can be inhibited.

### Embodiment 2

### Overall Configuration

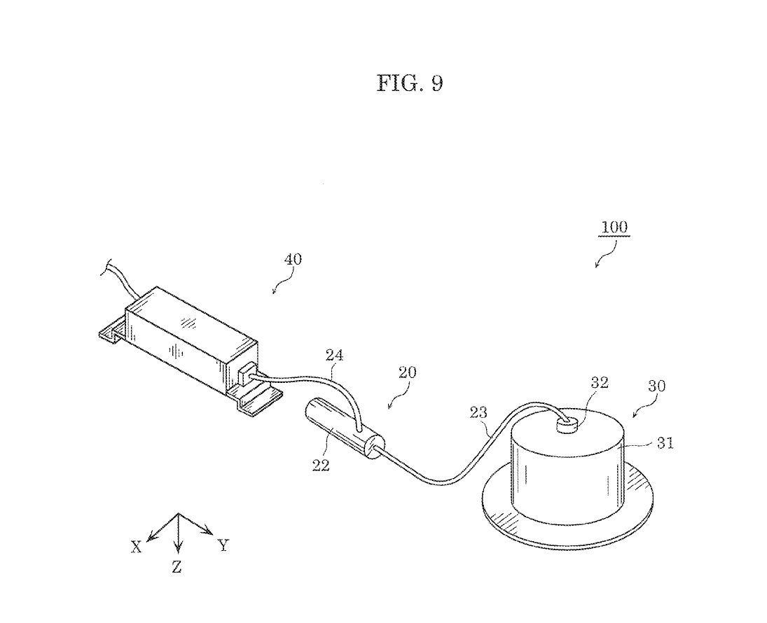

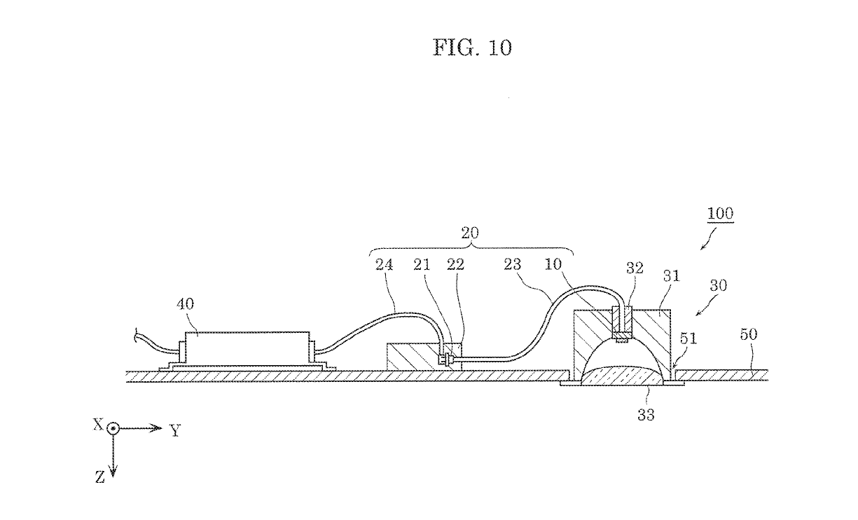

In Embodiment 2, a light source device including wavelength conversion device 10, and a lighting apparatus including the light source device will be described. FIG. 9 is an external perspective diagram of a lighting apparatus according to Embodiment 2. FIG. 10 is a schematic cross-sectional view which illustrates a use mode of the lighting apparatus according to Embodiment 2. It should be noted that, in FIG. 10, only the illustration of power supply device 40 shows a side surface instead of a cross-section surface.

As illustrated in FIG. 9 and FIG. 10, lighting apparatus 100 is a downlight to be attached to ceiling 50 of a building. Lighting apparatus 100 includes light source device 20, lighting device 30, and power supply device 40. Light source device 20 and lighting device 30 are optically connected via optical fiber 23. Light source device 20 and power supply device 40 are electrically connected via power supply cable 24.

Lighting apparatus 100 is mounted on ceiling 50 in a state in which lighting device 30 is inserted into opening 51 of ceiling 50. In other words, lighting apparatus 100 is disposed on a back surface of the ceiling except for a portion of lighting device 30.

### Light Source Device

Next, light source device 20 will be described in detail. Light source device 20 includes laser light source 21 which emits blue laser light and wavelength conversion device 10. Light source device 20 emits white light with the combination of laser light source 21 and wavelength conversion device 10. More specifically, light source device 20 emits white light including excitation light (blue laser light) and fluorescent light emitted by phosphor particles 12b. Light source device 20 includes laser light source 21, heat sink 22, optical fiber 23, power supply cable 24, and wavelength conversion device 10. It should be noted that light source device 20 may include wavelength conversion device 10a, wavelength conversion device 10b, wavelength conversion device 10c, or wavelength conversion device 10d, in place of wavelength conversion device 10.

Laser light source 21 is an example of an excitation light source which emits excitation light. Laser light source 21 is, for example, a semiconductor laser which emits blue laser light. The emission peak wavelength (center emission wavelength) of laser light source 21 is, for example, at least 440 nm and at most 470 nm. Laser light source 21 may emit blue-violet light or ultraviolet light. Laser light source 21 is specifically a CAN package element.

However, laser light source 21 may be a chip type element.

Heat sink 22 is a structure used for dissipating heat of laser light source 21 that is currently emitting light. Heat sink 22 houses laser light source 21 therein, and also functions as an outer casing of light source device 20. Heat sink 22 is capable of dissipating heat generated in laser light source 21 to heat sink 22. Heat sink 22 is formed using, for example, metal that is relatively high in thermal conductivity, such as aluminum or copper.

Optical fiber 23 guides laser light emitted by laser light source 21 to the outside of heat sink 22. Optical fiber 23 includes an entrance located inside heat sink 22. The laser light emitted by laser light source 21 enters the entrance of optical fiber 23. Optical fiber 23 includes an exit located inside lighting device 30. The laser light that exits through the exit is emitted to wavelength conversion device 10 located inside lighting device 30.

Power supply cable 24 is a cable for supplying, to light source device 20, power supplied from power supply device 40. Power supply cable 24 has one end connected to a power supply circuit in power supply device 40, and the other end connected to laser light source 21 through an opening defined in heat sink 22.

### Lighting Device

The following describes lighting device 30. Lighting device 30 is fitted to opening 51, and converts a wavelength of laser light guided by optical fiber 23 to emit light of a predetermined color. Lighting device 30 includes casing 31, holder 32, and lens 33.

Casing 31 is a cylindrical component having an open end on the Z-axis positive side and a closed-end on the opposite side, and houses holder 32, wavelength conversion device 10, and lens 33. The outer diameter of casing 31 is slightly smaller than the diameter of opening 51, and casing 31 is fitted to opening 51. Casing 31 is, more specifically, fixed to opening 51 using an attachment spring (not illustrated). Casing 31 is, for example, formed using metal that is relatively high in thermal conductivity, such as aluminum or copper.

Holder 32 is a cylindrical component which holds optical fiber 23, and includes a portion that is housed in casing 31. Holder 32 is disposed on an upper portion of casing 31. Optical fiber 23 is held, in a state in which optical fiber 23 is passed through a through hole provided along the center axis of holder 32. Holder 32 holds optical fiber 23 in such a manner that the exit of optical fiber 23 faces the Z-axis positive side (i.e., the exit faces wavelength conversion device 10). Holder 32 is formed using, for example, aluminum, copper, or the like. However, holder 32 may be formed using resin.

Lens 33 is an optical component which is disposed on an exit of casing 31, and controls distribution of light emitted by wavelength conversion device 10. Lens 33 is an example of the optical component which condenses or diffuses white light emitted by light source device 20 (wavelength conversion device 10). Lens 33 has a surface facing wavelength conversion device 10 and having a shape that enables taking light emitted by wavelength conversion device 10 into lens 33 with the leakage as least as possible.

### Power Supply Device

Next, power supply device 40 will be described. Power supply device 40 is a device which supplies power to light source device 20 (laser light source 21). Power supply device 40 houses a power supply circuit therein. The power supply circuit generates power for causing light source device 20 to emit light, and supplies the generated power to lighting device 30 through power supply cable 24. The power supply circuit is, specifically, an AC/DC converter circuit which converts AC power supplied from a power system into DC power, and outputs the DC power. Accordingly, direct current is supplied to laser light source 21.

### Advantageous Effects, etc., of Embodiment 2

As described above, light source device 20 includes: wavelength conversion device 10; and laser light source 21 that emits the laser light that enters incidence surface 11a.

With light source device 20 as described above, when a position at which laser light has a highest intensity in an emission range of the laser light overlaps light diffuser layer 14 in a plan view, laser light having a high intensity is diffused before the light enters phosphor layer 12. As a result, it is possible to inhibit laser light having a high intensity from directly entering phosphor layer 12, and local temperature rise in phosphor layer 12 can be inhibited.

In addition, as described in Embodiment 1, in light source device 20, for example, when viewed in the direction perpendicular to emission surface 11b, light diffuser layer 14 is disposed at a position at which the laser light has the highest intensity.

Accordingly, it is possible to inhibit laser light having a high intensity from directly entering phosphor layer 12, and local temperature rise in phosphor layer 12 can be inhibited.

In addition, as described in FIG. 4 of Embodiment 1, in light source device 20, for example, when viewed in the direction perpendicular to emission surface 11b, light diffuser layer 14 is disposed only in a region in which the laser light has an intensity greater than or equal to predetermined intensity I1. Predetermined intensity I1 is greater than 1/e² times peak intensity Iₚₑₐₖ of the laser light.

Accordingly, it is possible to inhibit laser light having an intensity greater than or equal to predetermined intensity I1 from directly entering phosphor layer 12, and local temperature rise in phosphor layer 12 can be inhibited.

It should be noted that light source device 20 may include wavelength conversion device 10a in place of wavelength conversion device 10. In this case, for example, as described in FIG. 5 of Embodiment 1, when viewed in the direction perpendicular to emission surface 11b, light diffuser layer 14 is disposed only in a region in which the laser light has an intensity greater than or equal to predetermined intensity I2. Predetermined intensity I2 is greater than 1/e times peak intensity Iₚₑₐₖ of the laser light.

With this configuration, it is possible to inhibit laser light having an intensity greater than or equal to predetermined intensity I2 from directly entering phosphor layer 12, and local temperature rise in phosphor layer 12 can be inhibited.

In addition, lighting apparatus 100 includes light source device 20 and lens 33 that condenses or diffuses light emitted by light source device 20. Lens 33 is an example of the optical component.

With lighting apparatus 100 as described above, when a position at which laser light has a highest intensity in an emission range of the laser light overlaps light diffuser layer 14 in a plan view, laser light having a high intensity is diffused before the laser light enters phosphor layer 12. As a result, it is possible to inhibit laser light having a high intensity from directly entering phosphor layer 12, and local temperature rise in phosphor layer 12 can be inhibited.

### Embodiment 3

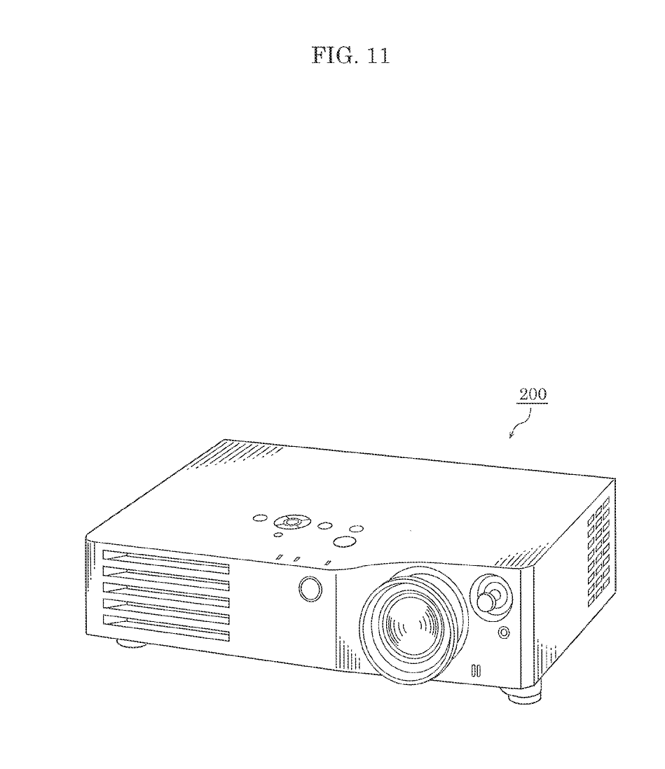

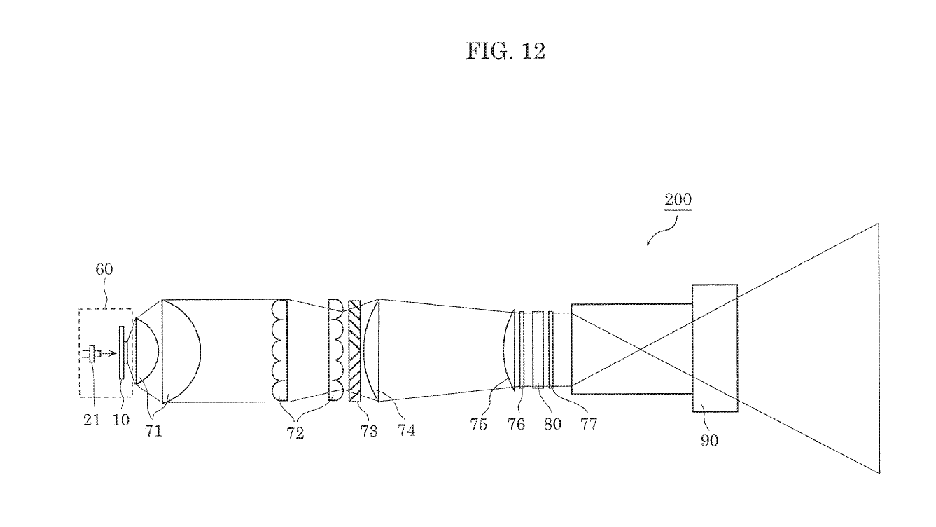

In Embodiment 3, a light source device including wavelength conversion device 10, and a projection image display apparatus including the light source device will be described. FIG. 11 is an external perspective view of the projection image display apparatus according to Embodiment 3. FIG. 12 is a diagram which illustrates an optical system of the projection image display apparatus according to Embodiment 3.

As illustrated in FIG. 11 and FIG. 12, projection image display apparatus 200 is a single-plate projector. Projection image display apparatus 200 includes light source device 60, collimate lens 71, integrator lens 72, polarized beam splitter 73, condenser lens 74, and collimate lens 75. In addition, projection image display apparatus 200 includes entrance-side polarization element 76, imaging element 80, exit-side polarization element 77, and projection lens 90.

Light source device 60 emits white light including excitation light (blue laser light) and fluorescent light emitted by phosphor particles 12b. Light source device 60 includes, specifically, laser light source 21 and wavelength conversion device 10. It should be noted that light source device 60 may include, wavelength conversion device 10a wavelength conversion device 10b, wavelength conversion device 10c, or wavelength conversion device 10d, in place of wavelength conversion device 10.

White light emitted by light source device 60 is collimated by collimate lens 71, and integrator lens 72 homogenizes an intensity distribution. The light whose intensity distribution is homogenized is converted to linearly polarized light by polarized beam splitter 73. Here, the light whose intensity distribution is homogenized is, for example, converted to p-polarized light.

The p-polarized light is incident on condenser lens 74, further collimated by collimate lens 75, and incident on entrance-side polarization element 76.

Entrance-side polarization element 76 is a polarization plate (polarization control element) which polarizes incident light toward imaging element 80. Exit-side polarization element 77 is a polarization plate which polarizes light that exits imaging element 80. Imaging element 80 is disposed between entrance-side polarization element 70 and exit-side polarization element 77.

Imaging element 80 is a substantially planar element which spatially modulates white light emitted by light source device 60, and outputs the spatially modulated white light as an image. Imaging element 80, stated differently, generates light for an image. Imaging element 80 is, specifically, a transmissive liquid crystal panel.

Since a polarization control region of entrance-side polarization element 76 transmits p-polarized light, light incident on entrance-side polarization element 76 enters imaging element 80, is modulated by imaging element 80, and exits imaging element 80. In addition, unlike entrance-side polarization element 76, exit-side polarization element 77 transmits only s-polarized light. Accordingly, only components of the s-polarized light included in the modulated light are transmitted through the polarization control region of exit-side polarization element 77, and are incident on projection lens 90.

Projection lens 90 projects an image output by imaging element 80. As a result, an image is projected on a screen or the like.

### Advantageous Effects, etc., of Embodiment 3

As described above, projection image display apparatus 200 includes; light source device 60; imaging element 80 that modulates white light emitted by light source device 60, and outputs, as an image, modulated white light; and projection lens 90 that projects the image output by imaging element 80.

With projection image display apparatus 200 as described above, when a position at which laser light has a highest intensity in an emission range of the laser light overlaps light diffuser layer 14 in a plan view, laser light having a high intensity is diffused before the laser light enters phosphor layer 12. As a result, it is possible to inhibit laser light having a high intensity from directly entering phosphor layer 12, and local temperature rise in phosphor layer 12 can be inhibited.

It should be noted that the optical system of projection image display apparatus 200 described in Embodiment 3 is one example. Imaging element 80, for example, may be a reflective imaging element such as a digital micromirror device (DMD) or a reflective liquid crystal panel. In addition, a three-plate optical system may be used in projection image display apparatus 200.

### Other Embodiments

Although Embodiments 1 to 3 have been described thus far, the present disclosure is not limited to the above-described embodiments.

For example, although the laser light source has been described as a semiconductor laser in the above-described embodiments, the laser light source may be a laser other than the semiconductor laser. The laser light source may be, for example, a solid-state laser such as a YAG laser, a liquid laser such as a pigment laser, or a gas laser such as an Ar ion laser, a He—Cd laser, a nitrogen laser, or an excimer laser. In addition, the light source device may include a plurality of laser light sources.

In addition, although the wavelength conversion device emits white light with the combination of blue laser light emitted to the wavelength conversion device and a yellow phosphor particle or a green phosphor particle according to the above-described embodiments, the configuration for emitting white light is not limited to this configuration. The phosphor layer may include a red phosphor particle, and the wavelength conversion device may emit white light with the combination of blue laser light, a red phosphor particle, and a yellow phosphor particle (or a green phosphor particle). The specific examples of red phosphor particle include CaAlSiN₃:Eu²⁺ phosphor, (Sr, Ca)AlSiN₃:Eu²⁺ phosphor, and the like.

In addition, the phosphor particle contained in the phosphor layer is not limited to an inorganic phosphor particle such as a YAG phosphor or a LuAG phosphor, and may be a quantum dot phosphor particle or the like.

In addition, the layered structure illustrated in the schematic cross-sectional view of the wavelength conversion device according to the above-described embodiments is one example. A wavelength conversion device having any other layered structure capable of implementing a characteristic function of the present disclosure is also included in the present disclosure. For example, another layer may be disposed between the layers of the above-described layered structure, to the extent that functions equivalent to the functions of the layered structure described in the forgoing embodiments can be implemented.

In addition, according to the foregoing embodiment, although main materials included in the layers of the layered structure of the wavelength conversion device are exemplified, each of the layers of the layered structure of the wavelength conversion device may include other materials, to the extent that functions equivalent to the functions of the layered structure described in the forgoing embodiments can be implemented.

It should be noted that the present disclosure also includes other forms in which various modifications apparent to those skilled in the art are applied to the embodiments or forms in which structural elements and functions in the embodiments, modifications, and examples are arbitrarily combined within the scope of the present disclosure.

While the foregoing has described one or more embodiments and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

What is claimed is:

1. A wavelength conversion device, comprising:
a light-transmissive substrate that includes an incidence surface and an emission surface opposite the incidence surface, and emits, from the emission surface, laser light that enters the incidence surface;
a phosphor layer that emits fluorescent light when excited by the laser light emitted from the emission surface; and
a light diffuser layer between the emission surface and the phosphor layer, wherein
when viewed in a direction perpendicular to the emission surface, the light diffuser layer is disposed only in a portion of a region in which the phosphor layer is disposed.

2. The wavelength conversion device according to claim 1, wherein
the light diffuser layer has a circular shape when viewed in the direction perpendicular to the emission surface.

3. The wavelength conversion device according to claim 1, wherein
the light diffuser layer has an annular shape when viewed in the direction perpendicular to the emission surface.

4. The wavelength conversion device according to claim 1, further comprising:
an optical thin film between the emission surface and the phosphor layer, the optical thin film having a property of transmitting the laser light and reflecting the fluorescent light.

5. The wavelength conversion device according to claim 4, wherein
the light diffuser layer is between the optical thin film and the phosphor layer.

6. The wavelength conversion device according to claim 4, wherein
the light diffuser layer is between the optical thin film and the emission surface.

7. A light source device, comprising:
the wavelength conversion device according to claim 1; and
a laser light source that emits the laser light that enters the incidence surface.

8. The light source device according to claim 7, wherein
when viewed in the direction perpendicular to the emission surface, the light diffuser layer is disposed at a position at which the laser light has a highest intensity.

9. The light source device according to claim 7, wherein
when viewed in the direction perpendicular to the emission surface, the light diffuser layer is disposed only in a region in which the laser light has an intensity greater than or equal to a predetermined intensity, the predetermined intensity being greater than 1/e² times a peak intensity of the laser light.

10. The light source device according to claim 7, wherein
when viewed in the direction perpendicular to the emission surface, the light diffuser layer is disposed only in a region in which the laser light has an intensity greater than or equal to a predetermined intensity, the predetermined intensity being greater than 1/e times a peak intensity of the laser light.

11. A lighting apparatus, comprising:
the light source device according to claim 7; and
an optical component that condenses or diffuses light emitted by the light source device.

12. A projection image display apparatus, comprising:
the light source device according to claim 7;
an imaging element that modulates light emitted by the light source device, and outputs, as an image, modulated light; and
a projection lens that projects the image output by the imaging element.

13. A projection image display apparatus, comprising:
the light source device according to claim 7;
a transmissive liquid crystal panel that modulates light emitted by the light source device, and outputs, as an image, modulated light; and
a projection lens that projects the image output by the transmissive liquid crystal panel.

14. The wavelength conversion device according to claim 1, wherein
the light diffuser layer has a multiangular shape when viewed in the direction perpendicular to the emission surface.

15. The wavelength conversion device according to claim 1, wherein
the light diffuser layer includes particles dispersed in a base material, and
the base material being a same material as a base material of the phosphor layer for inhibiting an interface from being formed between the phosphor layer and the light diffuser layer.

16. The wavelength conversion device according to claim 15, wherein
the particles include alumina or silica.

17. The wavelength conversion device according to claim 1, wherein
the light diffuser layer includes a base material that is different than a base material of the phosphor layer.

18. The wavelength conversion device according to claim 17, wherein
the base material of the light diffuser layer includes zinc oxide, the laser light being diffused by bubbles in the zinc oxide.

19. A wavelength conversion device, comprising:
a light-transmissive substrate that includes an incidence surface and an emission surface opposite the incidence surface, and emits, from the emission surface, laser light that enters the incidence surface; and
a phosphor layer that emits fluorescent light when excited by the laser light emitted from the emission surface, wherein
the light-transmissive substrate includes a light diffuser which diffuses the laser light that enters the incidence surface, and
when viewed in a direction perpendicular to the emission surface, the light diffuser is disposed only in a portion of a region in which the phosphor layer is disposed.
